(19) United States
(12) Patent Application Publication
(10) Pub. No.: US 2002/0194324 A1
(43) Pub. Date: Dec. 19, 2002

(54) System for global and local data resource management for service guarantees

(76) Inventor: Aloke Guha, Louisville, CO (US)

Correspondence Address: MCDERMOTT WILL & EMERY, 600 13TH STREET, N.W., WASHINGTON, DC, 20005-3096, US

(21) Appl. No.: 10/132,715

(22) Filed: Apr. 26, 2002

Related U.S. Application Data
(60) Provisional application No. 60/286,342, filed on Apr. 26, 2001.

(51) Int. Cl. G06F 15/16; G06F 15/173

(52) U.S. Cl. 709/223; 709/203; 709/226

(57) ABSTRACT

An end-to-end content management and delivery architecture is disclosed which provided for end-to-end content management from a data storage facility to an requestor remotely located. An End-to-End Content I/O Management (ECIM) contains a Global Infrastructure Control (GIC) that monitors the composite load levels at data centers across network servers, and identifies the best data center from which content request is met. Each data center has a QoS enforcer that monitors content arriving at the data center and controls the entry of all traffic at the data center. Each data center also has a controller, which controls the end-to-end I/O in the local data center. The ECIM allows end-to-end control of the content delivery, scalability provisioning of the application content storage pool to meet service level agreements; dynamic load balancing of the content, and optimization of the I/O resources both locally and across data centers so as to maximize the service level guarantees with minimum resource usage from application servers to storage.

### FIELD OF THE INVENTION

The present invention relates to data (content) and storage delivery with quality of service guarantees from one or more geographically distributed Internet or Intranet data centers.

Application Ser. No. 09/661,036, filed on Sep. 13, 2000, titled INTEGRATED CONTENT MANAGEMENT AND DELIVERY, to GUHA, is herein incorporated by reference.

### BACKGROUND OF THE INVENTION

With major network access and bandwidth investments, the content delivered over the Internet has evolved from small-scale, non-proprietary content to large-scale, rich or multimedia, and proprietary. Despite its elevation to mainstream status, improvements in the Internet infrastructure have been achieved in piecemeal fashion. From networks and servers to storage subsystems, the building blocks of a typical service provider or an enterprise data center have been cobbled together as independent enhancements have been made to each layer as illustrated in FIG. 9. The result has been limited performance improvement, with a high degree of complexity and total cost.

Because they lack robust content delivery architectures, client-to-disk (end-to-end) performance data and the tools to manage their data center operations, service providers and corporations have very limited control over their data centers. Absent comprehensive tools and control mechanisms, data center owners cannot offer meaningful data and content-level Service Level Agreements (SLAs). The growth in the volume of distributed content further compounds the problems of planning and managing system scalability, often resulting in large-scale capital investments just to maintain the status quo. In addition, new product opportunities that can exploit valuable content delivery are hampered by the inability to economically scale operations while estimating and maintaining reasonable service levels.

Data center owners lack the ability to allocate resources dynamically based on priorities in order to maximize end-to-end performance of content or data delivery. Resource allocation schemes, such as load balancing hardware and software solutions are available for individual components, for example, load balancing mechanisms for networks and servers. However, while content requests affect multiple components in the input-output (I/O) chain as illustrated in FIG. 9, there are no control mechanisms that span the I/O chain, especially beyond the server level. Therefore, SLAs on performance guarantees in delivering content is limited to very simple mechanisms at the individual resource level, such as packet delivery time across the network or spare computing capacity in the servers.

The current disclosure describes an end-to-end data and storage delivery SLA control mechanism, End-to-End Content I/O Management (ECIM), for content delivery by providing both monitoring functions and controls across the content stack underlying data and content applications.

From networks and servers to storage subsystems, the building blocks of a typical Internet or intranet data center have been haphazardly cobbled together as independent enhancements have been made to each. The result has been slightly improved performance with little reduction in the total cost of ownership (TCO).

While individual layers in networking (routers and load balancers), caching (caching devices or appliances), clustered servers and file systems, storage networking (Fibre Channel or Ethernet switches and directors) and storage subsystems, can be monitored and managed, there is no end-to-end control of a content request that spans the network request to the disk or storage subsystem.

A typical content request applied to the layout of FIG. 9, such as a specific file specified in an URL (e.g., http://www.xyz.com/content.html), may be: i) retrieved from the caching devices 98; or ii) retrieved from the cache of a server 910, if the file was not cached in the caching device; or iii) retrieved from storage 916, such as disk storage, where the network file system of the application data is located, if the server 910 does not have it on its local disk or memory. Thus, a response to content request can create I/O demands and associated traffic from the network and caching layer down to the storage subsystem layer 914. With a lack of effective observation tools that track all requests in real-time as they traverse the layers in the data center, there is a loss of control in managing distribution of the traffic requests down to the storage layer 914. Accordingly, if multiple content requests arrive concurrently at the storage 916 with different priorities, typically defined by some service level agreement (SLA) from the content or information provider, meeting these SLAs requires over-provisioning of network bandwidth, server capacity, switch port capacity and storage I/O capacity. When capital investment for overbuilding data center infrastructure is not a limiting constraint, meeting SLAs is relatively easy. However, a more cost-effective mechanism for meeting SLAs would be to have end-to-end observability and allocate I/O resources from the cache 98 to the storage subsystem based on priority. However, without adequate end-to-end control of the I/O resources, providing performance and therefore SLA guarantees is not feasible. The problem worsens as the volume of content data or storage requested over the network increases, i.e., data center I/O solutions do not scale.

Traditional solutions depend on controlling individual component layers of network, server 910, switch 914 (storage network or storage area network or SAN switch) and storage 916 (e.g. disk storage). These solutions rely on load balancing of the network traffic by a load balancer 94, or load balancing requests across servers, or within a single server or operating system, such as IBM's z/OS (IBM 2001) that claims support for quality of service (QoS) for transactions and data. Currently, data center administrators monitor each layer, e.g. router 92, network 912, server 910 or storage 916, separately, and do not possess a good observable and controllable environment where any content item, file or transaction, can be managed from an end-to-end perspective to guarantee performance in the delivery to the end client.

Additionally, most approaches treat all content requests as equal, with fair to poor results. Because of the lack of end-to-end control, the existing SLAs bear no relationship to the control of content delivery. Simple packet level SLAs such as packet delay, etc., or network availability, are poor indicators of how individual content, for example a data file, will be treated or the response time for a transaction request from a database, e.g., an electronic commerce system. The Internet is a large distributed computing system, and management and control can only be achieved from a component-neutral position, where content-specific business rules can be defined, monitored and dynamically adjusted to meet the needs of the end user who requests content. The problem of control must therefore be solved with an end-to-end or client-to-disk approach.

### SUMMARY OF THE INVENTION

These and other needs are addressed by the present invention. The present invention provides for an end-to-end content management and delivery architecture, from the disk system to the network client, with fine-grained service level guarantees.

In a preferred embodiment, the present invention includes a system for global and local data management comprising: a plurality of data storage centers, each data storage center including: a QoS enforcer that monitors content requests at an individual data storage center; and local controller which controls an individual data storage center and determines status information of an individual storage center; and a global infrastructure (GIC) control which controls the plurality of data storage centers, wherein said GIC receives status information from the local controller (LIC) of each data storage center of the multiple data storage centers and determines from which data storage centers of the multiple data storage centers to provide data to meet a content request.

The system of the preferred embodiment may further include a system, wherein said QoS enforcer contains a rule engine containing a predetermined QoS policy, and said GIC determines from which data storage centers of the multiple data storage centers to provide data to meet a content request according to said QoS policy and the status information. This may include the GIC determining the most temporally proximate data storage center from which the data can best be delivered to the requested of the data.

In the system of the present invention each data storage center may further include: at least one server device which communicates with the QoS enforcer; a network switch which communicates with the at least one server device; and at least one storage device which communicates with the SAN switch.

In the system of the present invention, the GIC may provide end-to-end control of content delivery to the end client over the Internet or intranet and control or partial or full replication of content between data centers.

In the system of the present invention provisioning of the application of a content storage pool may be scaled to meet service level guarantees.

In the system of the present invention content storage and I/O loads on the plurality of storage centers may be dynamically balanced.

The present invention may also include a method of managing data on a network having a plurality of data storage centers, each data storage center including: a QoS enforcer that monitors content requests at an individual data storage center; and local controller which controls an individual data storage center and determines status information of an individual storage center; and a global infrastructure (GIC) control which controls the plurality of data storage centers, the method comprising the steps of: receiving a content request at the QoS enforcer at a local data storage center; applying QoS enforcer rules to the content request and acting on the content request according to the QoS enforcer rules; updating a content request traffic profile in a local content controller; and applying QoS policy based load balancing by the local content controller.

The method of the present invention may also include in the step of applying QoS enforcer rules to the content request and acting on the content request according to the QoS enforcer rules, dropping the content request or delaying the content request when a QoS associated with the request is not high and a remote load of the architecture needed to comply with the request is high.

The method of the present invention may also include in the step of applying QoS enforcer rules to the content request and acting on the content request according to the QoS enforcer rules, routing the content request to the optimal data storage center to comply with the content request when a QoS associated with the request is not high and a remote load of the architecture needed to comply with the request is low.

The method of the present invention may further comprise the steps of: providing load information to the GIC from at least one data storage center indicative of a load on the respective data storage center; and determining the optimal data storage center of the plurality of data storage centers from which to deliver content.

In the method of the present invention, the step of determining the optimal data storage center of the plurality of data storage centers from which to deliver content, may determine the optimal data storage center based on the ability of the storage centers to meet a service level agreement.

The method of the present invention includes the GIC controlling partial or full replication of content storage across multiple data storage centers managed by LICs to improve availability of data as well as improve performance of data access by providing geographic replication of data and thus guaranteeing better proximity of the data to an arbitrarily located request.

The present invention may also include a computer readable medium carrying instructions for a computer to manage data on a network having a plurality of data storage centers, each data storage center including: a QoS enforcer that monitors content requests at an individual data storage center; and local controller which controls an individual data storage center and determines status information of an individual storage center; and a global infrastructure (GIC) control which controls the plurality of data storage centers, the instructions instructing the computer to perform a method comprising the steps of: receiving a content request at the QoS enforcer; applying QoS enforcer rules to the content request and acting on the content request according to the QoS enforcer rules; updating a content request traffic profile in a local content controller; and applying QoS policy based load balancing by the local content controller.

### BRIEF DESCRIPTION OF THE DRAWINGS

The accompanying drawings, which are incorporated in and form a part of the specification, illustrate the various embodiments of the present invention, and together with the description, serve to explain the principles of the invention. In the drawings:

FIG. 1 illustrates an exemplary block diagram layout of the End-to-End Content I/O Management (ECIM) according to the present invention.

FIG. 2a illustrates the layer hierarchy of a data management system which does not include the ECIM of the present invention.

FIG. 2b illustrates an overview of the End-to-End Content I/O Management (ECIM) for optimizing resource allocation to maximize SLA support by managing a consolidated content storage pool for applications in response to content requests on the network;

FIG. 3 illustrates an exemplary QoS Enforcer with Rule Engine for monitoring and directing content requests arriving at the data center to meet QoS needs;

FIG. 4 illustrates linking QoS Enforcement actions to a content controller managing the Content Storage Pool;

FIG. 5 illustrates a Local Content (Storage) Pool managed by a content controller operating in conjunction with the QoS Enforcer;

FIG. 6 illustrates an exemplary Content Management System within a single data center;

FIG. 7 illustrates an exemplary flowchart depicting the operation of the ECIM according to the present invention;

FIG. 8 illustrates an exemplary flowchart describing the processing of content request from its arrival at a data center through the QoS Enforcer to the content controller; and

FIG. 9 illustrates a conventional layout of a data center infrastructure.

### DETAILED DESCRIPTION OF THE INVENTION

Reference will now be made in detail to the present preferred embodiment of the invention, an example of which is illustrated in the accompanying drawings. The process of the content request routing in the data center where ECIM is used is first summarized, and then the preferred embodiment is described.

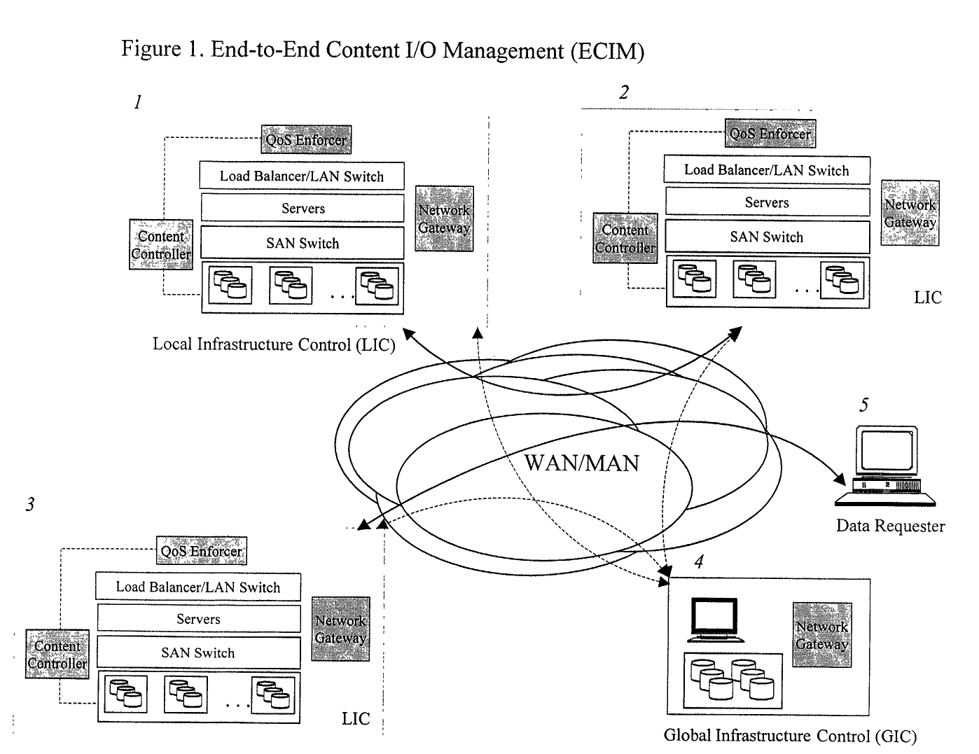

In the present invention the delivery of content is controlled by an end-to-end content management and delivery architecture, from the disk system to the network client, with fine-grained service level guarantees. In the preferred embodiment, with reference to FIG. 1, an End-to-End Content I/O Management system (ECIM), includes a Global Infrastructure Control (GIC). The Global Infrastructure Control (GIC) preferably comprises a control mechanism across multiple data centers where content is stored either via full replication or caching. The function of the GIC is to i) monitor the composite load levels at a data center across the network, servers and storage layers, ii) identify the best data center location from which a content request is met, and iii) ensure data availability and data access performance by controlling replication of data across multiple data centers. It is assumed that global monitoring of the data center operations, where the GIC resides, is done through a typical network operations center (NOC) that maintains real-time status of the network and servers and the I/O status at each site. The load information from each data center enables the GIC to make macro-level decisions regarding the best site from which to deliver content to meet SLA needs. The NOC also records data maintained or delivered for customers who co-locate or host their application data at the data centers. The GIC can be located independent of the location of the LICs, but could be co-located with one of the LICs.

The ECIM also includes a Content Requests Monitoring and SLA Enforcement device. Preferably, each data center has a QoS Enforcer that both monitors content requests that arrive at the data center and controls the entrance of all traffic. The QoS Enforcer ascertains and enforces the routing of the content request in at least one of three possible ways: (i) route into the local data center so that it can be served locally from cache, server or from storage; (ii) reroute to an external data center based on information received from the GIC in the NOC; and/or (iii) drop or delay the request if the SLA needs are not the highest priority relative to other pending content requests and the load at the local and at other data centers.

The ECIM also includes a Local Application Infrastructure Control device. Preferably, the local application infrastructure comprises data centers where content and data management resides. Typical content infrastructure includes the following chain of a load balancer, router, caching appliances, web or application servers, local network switches or hubs (typically switched Ethernet), filter appliances, Fibre Channel storage area networks (SANs), and storage subsystems such as disk subsystems, as shown in FIG. 1. Controlling the end-to-end I/O in the local data center using the content controller described later provides SLA control.

In the preferred embodiment, the End-to-End Content I/O Management (ECIM) system is embedded at each data center and at the NOC.

In the preferred embodiment, the GIC coordinates the global load balancing by providing status information to each data center to make local decisions for managing and optimizing content delivery. This would also include keeping track of the availability of a data center, in the case of a system or network failure, or in the case of scheduled uploading or publishing of new content, or hardware or software upgrades. Using information from the GIC through the NOC that it controls, a set of data centers can determine the best site from which to deliver the content.

The GIC functions preferably include at least one of: collecting status information from data centers; providing near real-time information on the operational status of data centers, specifically to the local application infrastructure control, the content controller, at individual data centers; scheduling and coordinating upgrade time windows when specific data centers are taken off-line, either for infrastructure upgrades or updates of content (publishing); initiating replication of content between data centers for purposes of data availability and improvement of access performance.

Content requests are monitored via a QoS enforcing system, the QoS Enforcer, that tracks every request to content, e.g., requests to a web server, specified by an URL (Universal Resource Locator) via an HTTP connection, requests to a file (FTP) server, specified by a virtual or physical IP address, or connection to a database server (DBMS) using a web server as a front-end.

The QoS Enforcer makes simple routing decisions to provide QoS-based load balancing. The routing decisions are determined through a combination of preset QoS policy and current expected load at the data center. These decision making rules can generally be coded in a rule-based system or a Rule Engine that associates the QoS policy, such as priority, response time or data rate that should be maintained, with the content specific to the URL or IP address that identifies the application server and its I/O chain that is involved in delivering the content. Most importantly, information on the application servers and their I/O loads are provided continuously as input to the QoS Enforcer from the content controller. The Rule Engine applies QoS policy and the current load information to determine associated actions such as whether and where to forward the request.

Thus, the ECIM architecture depicted in FIG. 1 illustrates three data centers and LICs (1, 2 and 3) and the GIC 4 that, together, provide end-to-end content and storage management to a data requester 5. The GIC 4 coordinates the data movement activities across the LICs. For example, these coordinated activities can include keeping the status information on the load, or activity level, and health of each LIC; determining the location of specific data at the different LICs; initiating and controlling partial or complete replication of data across the LICs (this is depicted as dashed lines in FIG. 1); controlling recovery in the case of fail-over of an LIC to include determining which LIC will be the backup site for data of the LIC that fails; and determining which LIC is most time-proximate to the data requester 5. Each LICs responsibilities can include managing local content storage and guaranteeing an appropriate QoS of data to the requester 5. To accomplish this, an LIC, for example, controls location and management of content storage at the local data center; carries out data replication or mirroring activity in coordination with other LICs (this is depicted as the solid lines in FIG. 1); deliver data to the data requester 5 (shown by the solid line to the requester); and coordinate with the GIC if it cannot meet QoS of delivery of data requested either due to congestion, failure or other reasons. In FIG. 1, the GIC is depicted separately from the LICs merely to reflect that its location is independent from that of the LICs; however, the GIC can in certain embodiments of the present invention be co-located with an LIC.

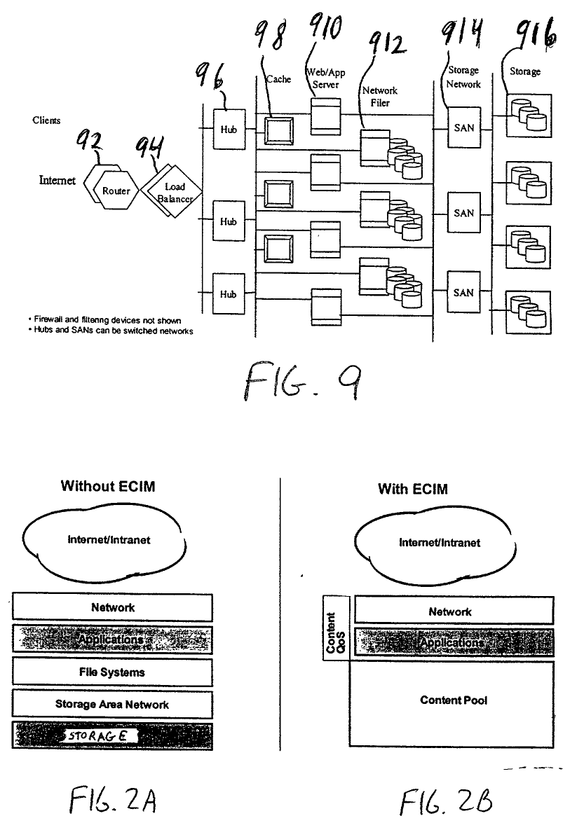

FIG. 2A illustrates the conventional conceptual architecture without the ECIM of the present invention, and FIG. 2B illustrates a conceptual architecture with the ECIM of the present invention. The ECIM greatly simplifies the architecture and optimizes resource allocation to maximize SLA support by managing a consolidated content storage pool for applications in response to content requests on the network.

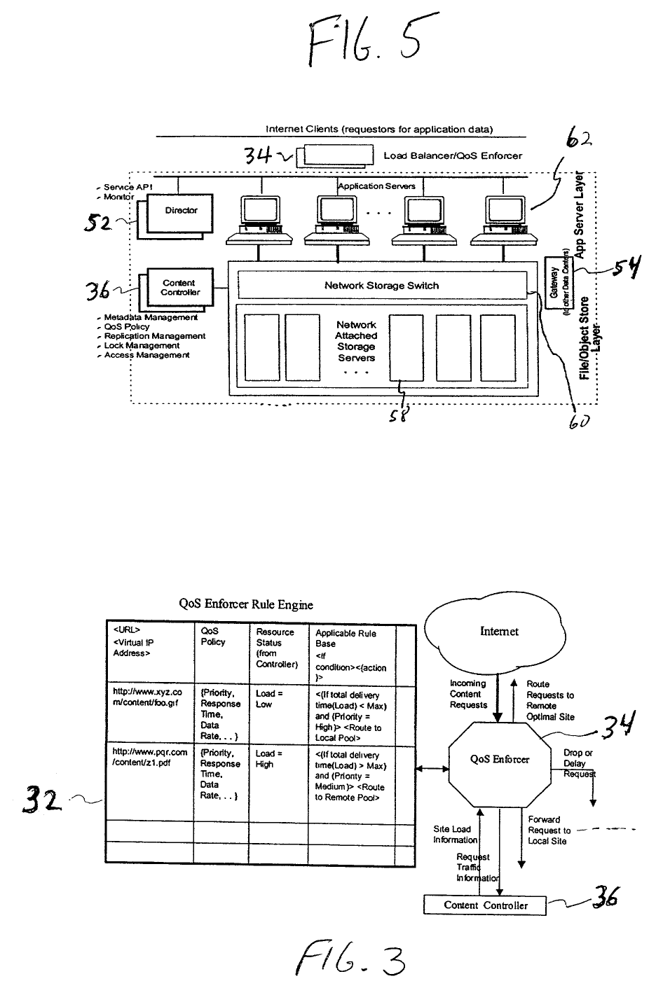

An example of a rules table 32 and the interaction between the QoS Enforcer 34 and the content controller 36 is shown in FIG. 3. In the preferred embodiment, the QoS Enforcer 34 comprises a network routing device, preferably a load balancing network device (Load Balancer) such as from F5, a Layer 4 or URL switching, such as from Foundry Network, Cisco Arrowpoint switch, and a rules engine that controls the routing decisions of the load balancer. The rules engine can be implemented on any computing platform that can quickly process the rules for decision-making. The rules can be defined using a lookup table 32 that associates a combination of conditions, such as the load at the data center and the QoS class for the content request, with actions on routing.

In the preferred embodiment, the rules table 32 contains a QoS policy for each designated address, as well as Resource Status information, and an Applicable Rule Base. The QoS policy is well known in the art and preferably contains information such as: priority, response time, data rate, etc. The Resource Status preferably contains information received from the content controller 36 which indicates the status of the components which retrieve the data, such as a “high” load status or a “low” load status.

The content controller 36 operates as the central management system. Preferably, the content controller 36 maintains and controls the metadata associated with all content data in the local data center under the control of the ECIM. The content controller 36 may be implemented by any computing platform with local storage to maintain persistent content metadata, either stored in a real-time database or a specialized file system that provides fast access. It preferably communicates over the local network or via direct connection to the set of application servers and the storage servers comprising the content storage pool, and also to the QoS Enforcer 34. Metadata is a term used in the broadest sense and includes, but is not limited to:

Content/Data Type: real-time, streaming or multimedia, text, imagery, application-specific (e.g., database entry, etc.);

Content/Data Location: location of content file or object within the content storage or file servers maintained by ECIM;

Storage and Access Management: monitor and ensure that content is stored appropriately for extensibility (e.g., a content provider's directory or DB may span multiple storage servers for scalability), proactive storage allocation from the storage pool, allocation to ensure prevention of access hot spots;

Access Control/Rights: security information, etc., that is most likely independent of the operating system of the server that data is accessed from, or by the client that is accessing or request the data;

Replication: the data owner may specify the need to make real-time copies of (data (on-demand replication), either locally for improving response times to multiple content requests or for increasing fault tolerance in the event of a failure of a site that holds the data (this is in coordination with other ECIM controllers and the local QoS Enforcer);

Usage Information: this indicates how many times the data is read, written, etc. All content access or usage record is kept for billing and audit purposes;

SLA (for I/O) Information: the I/O rate, response time, etc., at which the data is expected to be delivered; and

Recovery Information: where the data can be recovered from in the case of failure of the storage entity in the content pool that maintains the master copy of the data (this may be used in case of distributed content delivery (i.e., when a large file/object is delivered from multiple servers in different sites using multiple ECIMs)).

A further description of the preferred content controller capability can be found in U.S. application Ser. No. 09/661,036, filed on Sep. 13, 2000 to GUHA, previously mentioned and herein incorporated by reference. In summary, the content controller performs the following functions:

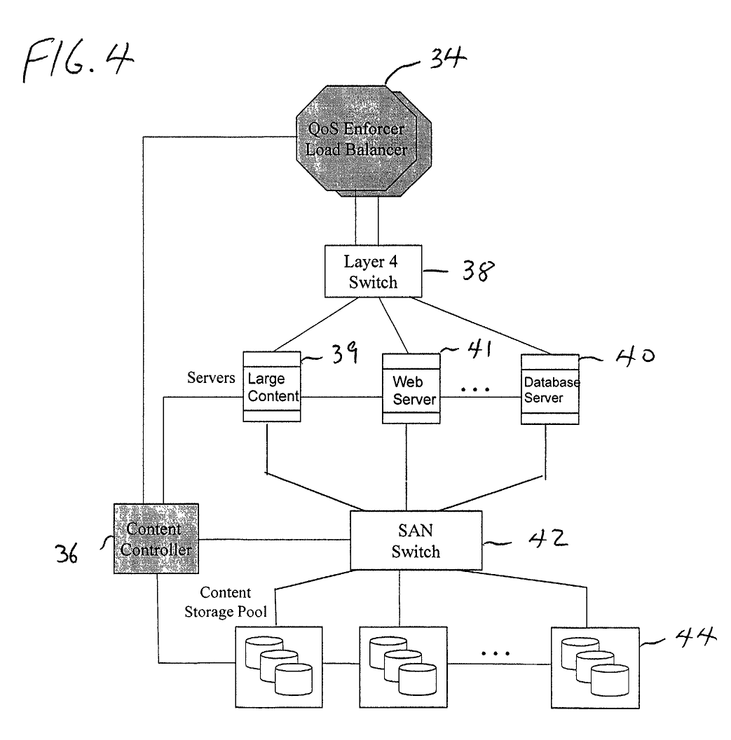

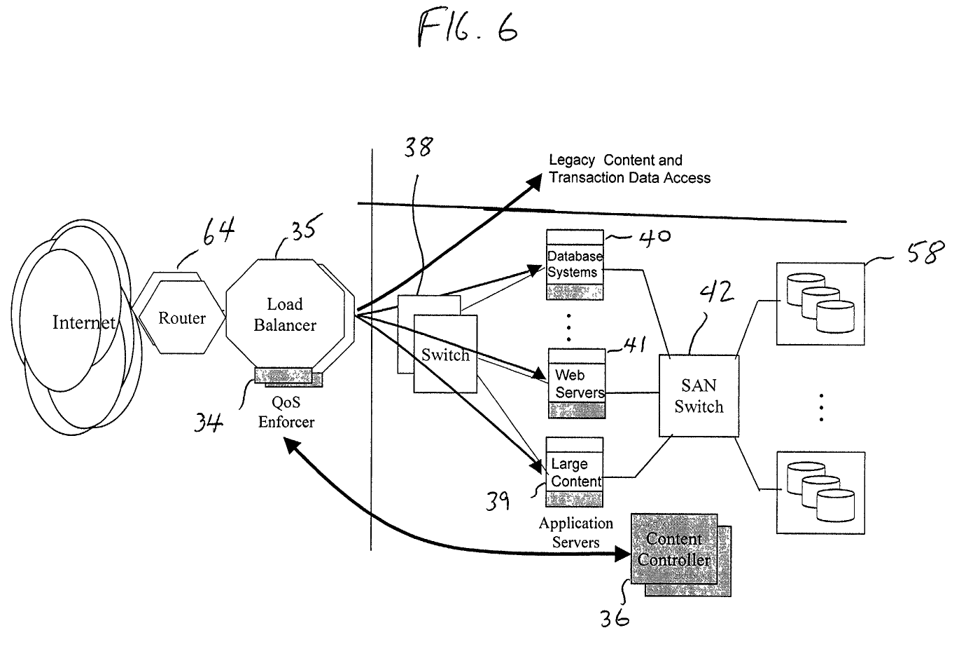

Provisioning: allocates content for different applications in a virtual content file or storage system that consolidates a pool of storage at the file level or block level across a storage area network, shown as the SAN Switch in FIGS. 4 and 5. The allocation is done to meet the SLA needs of the content delivery that are specified at the time the content is provisioned in the content pool.

Metadata Management: maintains and manages the metadata for all content managed by the content controller.

SLA Support: the content controller uses content request information from the QoS Enforcer captured at the entry point of the data center to dynamically allocate or deallocate content storage. This includes creating replicated files or data to increase bandwidth to increase availability of the backend content, providing priority-based load balancing and alleviating hot spots in the access to the backend content managed by the content controller to meet SLAs.

The content controller 36 of an LIC and its interaction with the QoS Enforcer are shown in FIG. 4. In FIG. 4, the QoS enforcer 34 communicates, through a layer switch 38, with a plurality of servers, such as a large content server 39, a web server 41, and a database server 40. The plurality of servers communicate with storage devices 44 through a network storage switch 42 (i.e., SAN switch). In the embodiment of FIG. 4, the content controller communicates with the storage devices 44 and with the SAN switch 42.

FIG. 5 shows another embodiment of an LIC and the content controller 36 and the content storage pool it manages. The LIC of this embodiment preferably contains application servers 62. The application servers 62 access the data from the content storage managed by the ECIM. An application server adapter may also be included in the form of “client” software that runs on the application servers that access the data from the content storage managed by the ECIM. For example, in one implementation, the adapter may treat the application servers as NFS/CIFS clients and access all data from the storage servers behind the network storage switch 60 on the behalf of the server. The Application Server Adapter also preferably monitors performance observed from the application server perspective. The content controller 36 provisions content storage at a data center by managing all content metadata. The content controller 36 works in conjunction with a NOC (not shown) to ensure that multiple distributed ECIMs can cooperate to provide highly available and high performance data access, a caching/replicating network function, and content delivery from distributed sites.

The LIC illustrated in FIG. 5 also contains a director 52. The director 52 is preferably a monitoring service, implemented on a standard computing platform, that checks the health of the application servers 62 that extract content data from the ECIM content storage 58. The Director may also be used to launch distributed data processing requests across the networked content storage.

The LIC of FIG. 5 further contains a gateway 54. The gateway 54 preferably provides the network routing function, as well as other data services such as authenticating remote sites or encrypting the data before the transfers are made. Typically, the gateway 54 will be a network device that provides a connection between the remote ECIM network storage switches across a wide area connection, as known to those of skill in the art.

FIG. 6 shows how a request received at the data center is routed from the router 64 through load balancer 35, QoS enforcer 34, layer switch 38, servers 39-41, SAN switch 42 to the storage (e.g., disk) system 58. In this example, three classes of application servers are shown: a web server 41, a transaction server using a database system 40, and a large content (file) server 39. Each class of the application server may be mapped to many physical servers to provide scalability in I/O. For example, by tracking the requested URL, the QoS Enforcer can direct the content request to the appropriate application server.

Each application server preferably accesses its content via a SAN switch 42. The content storage pool is preferably controlled by the content controller 36 on the LIC. As traffic for content requests for each class of application increases, the QoS Enforcer 34 controls the routing into the data center via the Load Balancer 35, typically implemented by an URL or Layer 4 switch, that directs the request to the selected application server. Based on the policy specified in the QoS Enforcer 34, content requests may be dropped or requeued (if the request is of low priority, requeueing will delay the request and let other higher-priority requests be satisfied first), admitted into data center or rerouted to another data center if its SLA cannot be met at the current site.

Most importantly, based on traffic levels observed and communicated by the QoS Enforcer 34 to the content controller 36, additional resources at the server and storage levels can be reassigned in the content pool to improve I/O access and the SLA needs of the content requests. A specific implementation for a high-priority content request would preferably be as follows. If the expected traffic increases to, for example, more than 75% load that is nominally expected, the content controller 36 might create and allow access to replicate web content that is accessed by the web server 41. Thus, if more application servers are allowed to handle web page requests from a “web server”, these application servers, constituting the web server, can then access more physical pages from the replicated files in the content storage pool, improving access times for the web page retrieval. This principle can be applied to any application's data. The combination of the QoS Enforcer 34 and the content controller 36 therefore allows dynamic allocation of I/O resources based on I/O load created at the network and the prespecified SLA to be met for all content requests. This mechanism allows the data center operator to maximize the SLA needs with a limited amount of data and I/O resources, maximizing the SLA support with least cost.

In summary, the ECIM system of the present invention allows the following capabilities: End-to-end control of content delivery to the end client; Scalable provisioning of the application content storage pool to meet service level guarantees; Dynamic load balancing of the content storage and I/O based on service level needs; and Optimization of the I/O resources so as to maximize service level guarantees with minimum resource usage from application servers to storage.

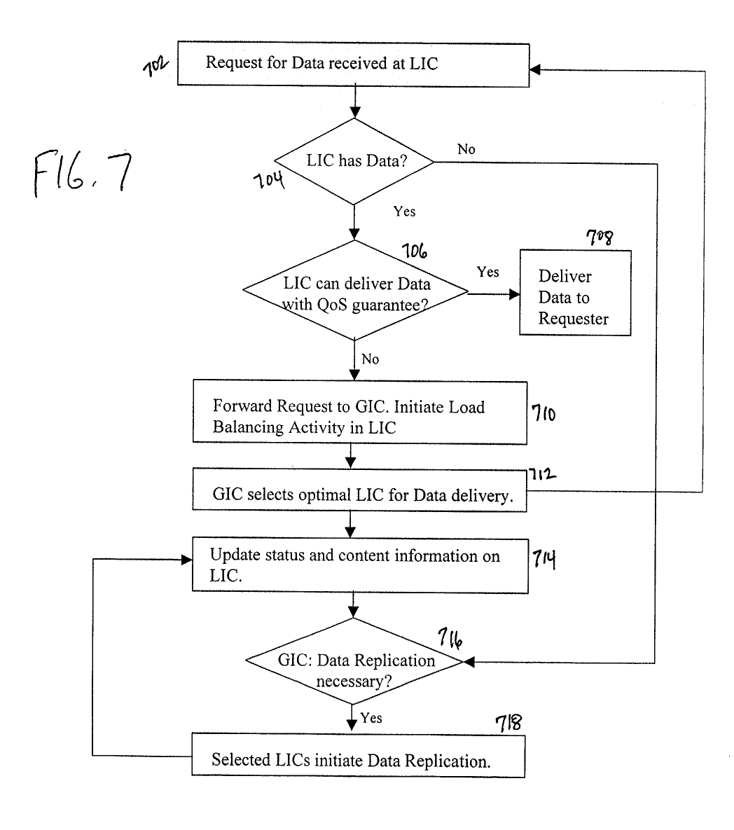

The flowchart of FIG. 7 depicts an overview of the typical interaction between the GIC and the LICs involved in data delivery and replication. In step 702, a request for data is received at an LIC associated with a data center. The LIC initially determines, in step 704, whether the data is locally stored at the data center. If the LIC has the requested data, then in step 706 a determination is made whether or not the LIC can deliver the data in such a way as to satisfy the QoS guarantee. If so, then the LIC delivers the data to the requester in step 708. However, if the QoS guarantee cannot be satisfied (in step 706), then the request is forwarded by the LIC to the GIC where the GIC initiates, in step 710, load balancing activity among the LICs. In step 712, the GIC selects the optimal LIC for delivering the data and sends a request for the data to that LIC.

The GIC, in step 714, also updates the status and content information on the LIC and determines, in step 716, whether or not data replication is necessary. As can be seen from the flowchart, the determination in step 704, if negative, can also result in the GIC, in step 716, determining if data replication is necessary. If so, appropriate LICs are selected, in step 718, for the initiation of data replication. Any changes regarding an LIC's status and content are then updated, in step 714. Once data is replicated to an LIC, that LIC can service the data request.

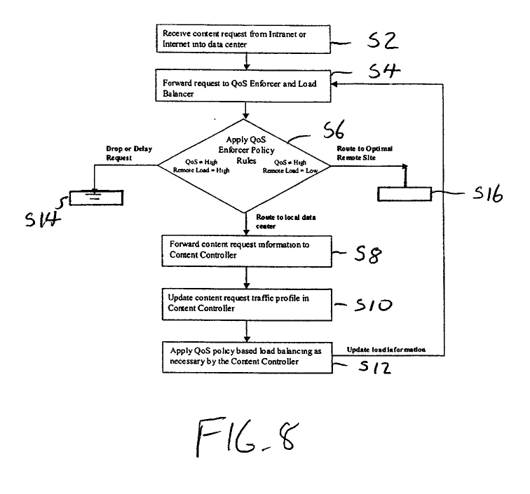

FIG. 8 is an exemplary flowchart that describes content request flow through the data center from the request at the router through the QoS enforcer 34 to the content storage system managed by the content controller 36 of an LIC. As illustrated in FIG. 8 the content request is received from the Internet or an intranet by the LIC data center (step S2). The request is forwarded to the QoS enforcer 34 and load balancer 35 (step S4). The rules of the QoS enforcer 34 are applied to the received request (step S6) and the request is handled according to the rules and the determined status of the components designated to retrieve the content. For example, if the QoS that can be provided is not high and the remote load of the architecture needed to comply with the request is high, then the request is delayed or dropped (step S14). Alternatively, if the QoS is not high and the remote load of the architecture needed to comply with the request is low, then the request is routed to an optimal remote site to be acted on (step S16). The QoS also forwards the content request information to the content controller 36 (step S8). The content controller 36 updates the content request traffic profile in the content controller 36 (step S10). The content controller 36 determines if load balancing is required and based on the traffic profile and applies the QoS policy based load balancing if needed (step S12).

The steps of the flow diagrams are preferably implemented by one or more computers. One or more computer programs may be recorded on a computer readable medium which, when read by one or more computers, render the one or more computers operable to perform these steps. The term computer readable medium is intended to be broadly construed as any medium capable of carrying data in a form readable by a computer, including, but not limited to, storage devices such as discs, cards, and tapes, and transmission signals such as modulated wireline or wireless transmission signals carrying computer readable data.

The foregoing description of a preferred embodiment of the invention has been presented for purposes of illustration and description. It is not intended to be exhaustive or to limit the invention to the precise form disclosed, and obviously many modifications and variations are possible in light of the above teaching. For example, the components of the ECIM system can be implemented in multiple ways without departing from the spirit of the invention.

What is claimed is:

1. A system for global and local data management comprising:
a plurality of data storage centers, each data storage center including:
a QoS enforcer that monitors content requests at an individual data storage center;
a local controller which controls an individual data storage center and determines status information of an individual storage center; and
a global infrastructure (GIC) control which controls the plurality of data storage centers,
wherein said GIC receives status information from the local controller of each data storage center of the multiple data storage centers and determines from which data storage centers of the multiple data storage centers to provide data to meet a content request, and wherein said GIC initiates replication of data between data storage centers to improve data availability and data access performance.

2. The system of claim 1, wherein said QoS enforcer contains a rule engine containing a predetermined QoS policy, and said GIC determines from which data storage centers of the multiple data storage centers to provide data to meet a content request according to said QoS policy and the status information.

3. The system of claim 1, wherein said QoS enforcer includes a load balancing network device.

4. The system of claim 1, wherein each data storage center further includes:
at least one server device which communicates with the QoS enforcer;
a network switch which communicates with the at least one server device; and
at least one storage device which communicates with the network switch.

5. The system of claim 4, wherein a content controller communicates with the network switch and the at least one storage device.

6. The system of claim 1, wherein the GIC provides end-to-end control of content delivery to the end client over the Internet or intranet.

7. The system of claim 1, wherein provisioning of the application of a content storage pool is scaled to meet service level guarantees.

8. The system of claim 1, wherein content storage and I/O loads on the plurality of storage centers are dynamically balanced.

9. A method of managing data on a network having a plurality of data storage centers, each data storage center including: a QoS enforcer that monitors content requests at an individual data storage center; and local controller which controls an individual data storage center and determines status information of an individual storage center; and a global infrastructure (GIC) control which controls the plurality of data storage centers, the method comprising the steps of:
receiving a content request at the QoS enforcer;
applying QoS enforcer rules to the content request and acting on the content request according to the QoS enforcer rules;
updating a content request traffic profile in a local content controller; and
applying QoS policy based load balancing by the local content controller.

10. The method of claim 9, wherein the step of applying QoS enforcer rules to the content request and acting on the content request according to the QoS enforcer rules includes dropping the content request or delaying the content request when a QoS associated with the request is not high and a remote load of architecture needed to comply with the request is high.

11. The method of claim 9, wherein the step of applying QoS enforcer rules to the content request and acting on the content request according to the QoS enforcer rules includes rotating the content request to an optimal data storage center to comply with the content request when a QoS associated with the request is not high and a remote load of architecture needed to comply with the request is low.

12. The method of claim 9, further comprising the steps of:
providing load information to the GIC from at least one data storage center indicative of a load on the respective data storage center; and
determining an optimal data storage center of the plurality of data storage centers from which to deliver content.

13. The method of claim 12, wherein the step of determining an optimal data storage center of the plurality of data storage centers from which to deliver content, determines the optimal data storage center based on the ability of the storage centers to meet a service level agreement.

14. A computer readable medium carrying instructions for a computer to manage data on a network having a plurality of data storage centers, each data storage center including: a QoS enforcer that monitors content requests at an individual data storage center; and local controller which controls an individual data storage center and determines status information of an individual storage center; and a global infrastructure (GIC) control which controls the plurality of data storage centers, the instructions instructing the computer to perform the method comprising the steps of:
receiving a content request at the QoS enforcer;
applying QoS enforcer rules to the content request and acting on the content request according to the QoS enforcer rules;
updating a content request traffic profile in a local content controller; and
applying QoS policy based load balancing by the local content controller.

15. The computer readable medium of claim 14, wherein the step of applying QoS enforcer rules to the content request and acting on the content request according to the QoS enforcer rules includes dropping the content request or delaying the content request when a QoS associated with the request is not high and a remote load of the architecture needed to comply with the request is high.

16. The computer readable medium of claim 14, wherein the step of applying QoS enforcer rules to the content request and acting on the content request according to the QoS enforcer rules includes routing the content request to the optimal data storage center to comply with the content request when a QoS associated with the request is not high and a remote load of the architecture needed to comply with the request is low.

17. The computer readable medium of claim 14, wherein the instruction further cause the computer to further performs the steps of:
providing load information to the GIC from at least one data storage center indicative of a load on the respective data storage center;
determining the optimal data storage center of the plurality of data storage centers from which to deliver content; and
controlling the replication of data between data storage centers to improve access performance and availability of data, in the case of failures in a data center containing the content.

18. The computer readable medium of claim 17, wherein the step of determining the optimal data storage center of the plurality of data storage centers from which to deliver content, determines the optimal data storage center based on the ability of the storage centers to meet a service level agreement.
